(19) United States
(12) Patent Application Publication
(10) Pub. No.: US 2005/0235635 A1
(43) Pub. Date: Oct. 27, 2005

(54) Exhause pipe assembly

(75) Inventor: Mark Benard, Woodstock (CA)

Correspondence Address: VALENTINE A. COTTRILL, SUITE 1020 50 QUEEN STREET NORTH, KITCHENER, ON, N2H6M2, CA

(73) Assignee: Hyper Dawg Inc., Woodstock (CA)

(21) Appl. No.: 11/108,790

(22) Filed: Apr. 19, 2005

Related U.S. Application Data
(60) Provisional application No. 60/564,607, filed on Apr. 23, 2004.

(51) Int. Cl. F02B 27/02; F02D 23/00

(52) U.S. Cl. 60/313

(57) ABSTRACT

An exhaust pipe assembly for directing exhaust gases from an internal combustion engine in a vehicle with a front end and a back end along a predetermined path. The exhaust pipe assembly has a body with a duct therein. The body has a back end proximal to the vehicle back end and a front end distal to the back end of the body. The duct defines a predetermined path and is positioned at least partially in the body. The duct has an intake end adapted to receive the exhaust gases from the engine and an output end located between the front end and the back end of the body, to direct the exhaust gases along the predetermined path to exit the body.

This application claims the benefit of U.S. Provisional Patent Application No. 60/564,607, filed Apr. 23, 2004.

### FIELD OF THE INVENTION

This invention is related to exhaust pipe assemblies.

### BACKGROUND OF THE INVENTION

Exhaust pipes for internal combustion engines are well known. Typically, an exhaust pipe on a motorcycle is positioned partly inside a housing with a chrome finish on the housing's exterior surface. In these circumstances, the housing is designed primarily for its decorative effect.

The prior art housing includes an exhaust pipe portion which extends linearly from the housing's front end to the housing's back end. Therefore, in the prior art, the exhaust pipe portion which is inside the housing is of substantially the same length as the housing. An exhaust pipe assembly, for the purposes hereof, includes a housing and an exhaust pipe at least partly positioned therein.

However, known exhaust pipes and housings therefor have a number of disadvantages. First, the exterior surface of the housing becomes relatively hot while the motorcycle engine is running. Burns, to a passenger or to a driver of the motorcycle, are relatively common as a result. Also, clothing worn by the passenger or the driver can become disfigured or marred upon contacting the hot housing.

Second, a motorcycle engine typically includes more than one cylinder, and the cylinders are often positioned in alignment from front to back, so that one cylinder is positioned forward of another cylinder. If the effective lengths of the exhaust pipes for each cylinder respectively are not substantially the same (i.e., “tuned”), engine performance is adversely affected. However, most original equipment provided by motorcycle manufacturers includes exhaust pipes which are not of the same effective length. This is because the typical original equipment housings are provided in a pair for a motorcycle, and are of substantially the same length. Where the cylinders are aligned front to back, this similarity in housing length therefore results in the exhaust pipes' effective lengths being unequal.

Furthermore, because a pair of original equipment manufacturer housings is usually of the same length, any exhaust system which includes housings of different lengths is immediately identifiable as not having been produced by the original equipment manufacturer. The appearance of a pair of housings having unequal lengths is generally thought to be less desirable.

There is therefore a need for an improved exhaust pipe assembly.

### SUMMARY OF THE INVENTION

In its broad aspect, the invention provides an exhaust pipe assembly for directing exhaust gases from an internal combustion engine in a vehicle with a front end and a back end along a predetermined path. The exhaust pipe assembly has a body with a duct. The body has a back end proximal to the vehicle back end and a front end distal to the back end of the body. The duct defines the predetermined path and is positioned at least partially in the body. The duct has an intake end adapted to receive the exhaust gases from the engine and an output end located between the front end and the back end of the body, to direct the exhaust gases along the predetermined path to exit the body.

In another of its aspects, the body includes one or more apertures at the back end thereof. The exhaust pipe assembly additionally includes one or more cap portions for covering said at least one aperture.

In yet another aspect, the cap portion includes at least one light source.

In yet another aspect, the invention provides a system including two exhaust pipe assemblies. Each of the exhaust pipe assemblies is adapted for directing exhaust gases from a first cylinder and a second cylinder of an internal combustion engine respectively along a predetermined path. The internal combustion engine is mounted in a vehicle with a front end and a back end. Each of the exhaust pipe assemblies has a body with a duct. The body has a back end proximal to the vehicle back end and a front end distal to the back end of the body. The duct defines the predetermined path and is positioned at least partially in the body. The duct has an intake end adapted to receive the exhaust gases from the cylinder and an output end located between the front end and the back end of the body, to direct said exhaust gases along the predetermined path to exit the body. Each of the output ends is located such that the predetermined path in each said duct has a preselected length.

### BRIEF DESCRIPTION OF THE DRAWINGS

The invention can be better understood with reference to the attached drawings, in which:

FIG. 1 is a cross-section of a preferred embodiment of an exhaust pipe assembly of the invention; and

FIG. 2 is a bottom view of a preferred embodiment of an exhaust system including two exhaust pipe assemblies.

### DETAILED DESCRIPTION OF THE PREFERRED EMBODIMENT(S)

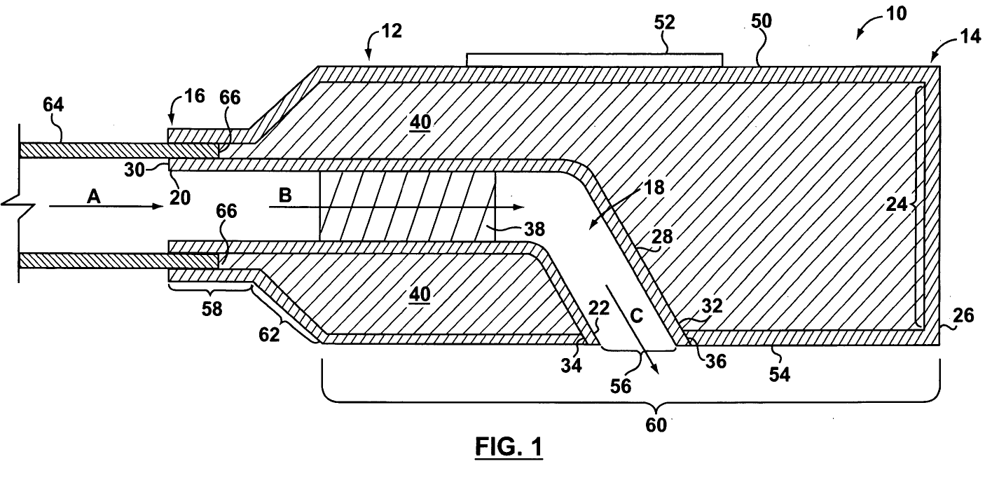

Reference is first made to FIG. 1 to describe a preferred embodiment of an exhaust pipe assembly indicated generally by the numeral 10 in accordance with the invention. As can be seen in FIG. 1, the exhaust pipe assembly 10 is for directing exhaust gases (not shown) from an internal combustion engine in a vehicle with a front end and a back end (not shown), along a predetermined path indicated generally by arrows A, B, and C. The exhaust pipe assembly 10 preferably includes a body 12 with a back end 14 proximal to the vehicle back end and a front end 16 distal to the back end 14 of the body 12. Preferably, the exhaust pipe assembly 10 also includes a duct 18 defining the predetermined path and positioned at least partially in the body 12. The duct 18 has an intake end 20 adapted to receive the exhaust gases from the engine and an output end 22 located between the front end 16 and the back end 14 of the body 12, to direct the exhaust gases along the predetermined path to exit the body 12.

Preferably, the body 12 includes an aperture 24 at the back end 14 of the body 12. As will be described, the exhaust pipe assembly 10 preferably also includes a cap portion 26 for covering the aperture 24.

The cap portion 26 can include a light source (not shown). This can be an important safety feature, as the light source can be connected so that the light source is turned off and on when the brakes are applied and released. Preferably, the light source is a light-emitting diode, which has the beneficial feature of requiring relatively little current.

The duct 18 is preferably formed by an inner pipe 28. A front end 30 of the inner pipe is preferably welded or otherwise attached in any suitable manner to the body 12 at the body's front end 16. The inner pipe 28 also has a back end 32 which preferably is welded or otherwise attached to the body 12 at intermediate points 34, 36.

In order to attenuate noise produced by the engine, a baffle element 38 is located in the duct 18. The baffle element 38 is positioned so that exhaust gases moving along the predetermined path pass through the baffle element 38.

In the preferred embodiment, insulation 40 is disposed between the body 12 and the duct 18, and a part 42 of the duct 18, as can be seen in FIG. 1. The insulation 40 is for minimizing heat transfer from the exhaust gases passing through the duct 18 to the body 12. Preferably, the insulation 40 is ceramic fibre, but any suitable insulating material could be used. The insulation 40 is preferably packed in the body 12 tightly, and remains in place during use. However, the insulation 40 may be held in place in the body 12, between the inner pipe 28 and the body 12, by any suitable retaining means.

Preferably, the body 12 has a top surface 50 and an attachment means 52 located on the top surface 50. The attachment means 52 is for mounting the assembly 10 on a coupler (not shown) on the vehicle. In the preferred embodiment, the body 12 also includes a bottom surface 54 opposed to the top surface 50 of the body 12, and the output end 22 is positioned on or proximal to the bottom surface 54, to form an exit aperture 56.

Preferably, the body 12 has a first generally cylindrical part 58 extending rearwardly from the front end 16 and a second generally cylindrical part 60 extending forwardly from the back end 14, with the second cylindrical part 60 having larger diameters (internal and external) than the first cylindrical part 58. As is known in the art, the first cylindrical part 58 and the second cylindrical part 60 are joined by a tapered part 62 which is generally frustoconical. The body 12 is preferably made of steel or any other suitable material, and an exterior surface of the body can be provided with a chrome finish. It will be appreciated by those skilled in the art that many forms and designs of the body 12 could be used.

Typically, the engine will include a pipe 64 through which exhaust gases are directed, the pipe leading from a cylinder (not shown) to an exit end 66 of the pipe 64. Preferably, the end 66 of the pipe 64 fits between the front end 30 of the inner pipe 28 and the front end 16 of the body 12, in a “slip fit”. The exhaust pipe assembly 10 is preferably attached to the exhaust pipe 64 by a manufacturer's exhaust clamp (not shown), as is known in the art.

The cap portion 26 is preferably attached to the back end 14 of the body 12 by screws (not shown) or any other suitable fasteners. Preferably, the cap portion 26 includes one or more decorative features (not shown).

For example, in the preferred embodiment, one or more light sources and/or light reflectors are mounted in the cap portion 26, and the light from the light source exits the cap portion 26 through openings therein (not shown). Such openings can be formed to shape words or logos. Because motorcycles typically provide only relatively limited rear lighting, the ability to provide additional rearwardly-directed lighting in the cap portion 26 is potentially a very important safety feature. For example, on a motorcycle used for law enforcement duty, the cap portion 26 could include one or more light sources adapted to flash appropriately, when a siren and other flashing lights on the motorcycle are activated.

Alternatively, the cap portion 26 can be a solid cap. The cap portion 26 can also include any pattern or ornament, as required.

In use, the exhaust pipe assembly 10 can be used to replace a prior art housing with an existing exhaust pipe (or portion thereof) positioned in the housing. The end 66 of the pipe 64 is received in the front end 16 of the body 12, and the attachment means 52 is attached to the coupler (not shown) on the vehicle, as is known in the art. The front end 16 of the body 12 may be attached to the end 66 of the pipe 64 by means of the manufacturer's exhaust clamp. The cap portion 26 is attached to the back end 14 of the body 12.

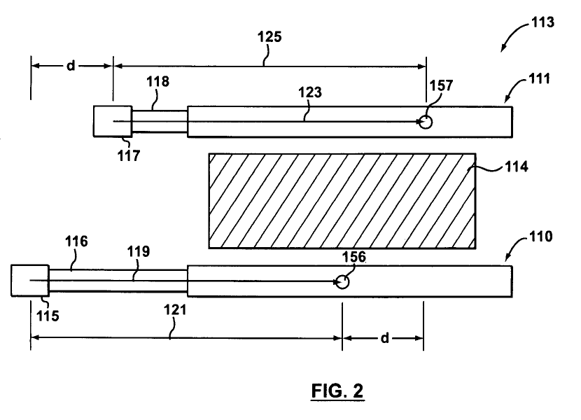

As can be seen in FIG. 2, two exhaust pipe assemblies 110, 111 form an exhaust system 113. The exhaust pipe assemblies 110, 111 are preferably positioned on opposite sides of a rear wheel 114 of the motorcycle. Typically, a motorcycle's engine (not shown) includes two cylinders, positioned so that a first cylinder (indicated generally by the numeral 115) is located generally forwardly of a second cylinder (indicated generally by the numeral 117). Preferably, the cylinders 115, 117 are connected to the exhaust pipe assemblies 110, 111 by pipes 116, 118 respectively.

In the preferred embodiment of the system 113, a first exhaust gas path 119 extends a first distance 121 from the first cylinder 115 to a first exit aperture 156. Similarly, and as shown in FIG. 2, a second exhaust gas path 123 preferably extends a second distance 125 from the second cylinder 117 to a second exit aperture 157. As can be seen in FIG. 2, the first cylinder 115 is positioned a distance “d” ahead of the second cylinder 117. Because the first exit aperture 156 is also positioned ahead of the second exit aperture 157 by the distance “d”, the first distance 121 and the second distance 123 are substantially equal. The engine is therefore “tuned”, for improved performance. As can be seen in FIG. 2, however, the exhaust pipe assemblies 110, 111 have the same overall length. Therefore, the system 113 provides improved performance but also a desirable overall appearance.

It will be evident to those skilled in the art that the invention can take many forms, and that such forms are within the scope of the invention as claimed. Therefore, the spirit and scope of the appended claims should not be limited to the description of the preferred versions contained herein.

1. An exhaust pipe assembly for directing exhaust gases from an internal combustion engine in a vehicle with a front end and a back end along a predetermined path, the exhaust pipe assembly having:
a body with a back end proximal to the vehicle back end and a front end distal to the back end of the body; and
a duct defining the predetermined path and positioned at least partially in the body, the duct having an intake end adapted to receive said exhaust gases from the engine and an output end located between the front end and the back end of the body, to direct said exhaust gases along the predetermined path to exit the body.

2. An exhaust pipe assembly as claimed in claim 1 in which the body includes at least one aperture at the back end thereof, and in which the exhaust pipe assembly additionally includes at least one cap portion for covering said at least one aperture.

3. An exhaust pipe assembly as claimed in claim 2 in which said at least one cap portion includes at least one light source.

4. An exhaust pipe assembly as claimed in claim 3 in which said at least one light source is a light-emitting diode.

5. An exhaust pipe assembly as claimed in claim 1 in which the duct includes a baffle element therein for attenuating noise produced by the engine, the baffle element being positioned such that exhaust gases moving along the predetermined path pass through the baffle element.

6. An exhaust pipe assembly as claimed in claim 1 in which insulation is disposed between the body and at least a part of the duct, for minimizing heat transfer from said exhaust gases passing through the duct to the body.

7. An exhaust pipe assembly as claimed in claim 1 in which the body has a top surface and in which the body additionally includes an attachment means located on the top surface, for coupling with a coupler on the vehicle.

8. An exhaust pipe assembly as claimed in claim 7 in which the body includes a bottom surface opposed to the top surface thereof, and in which the output end is positioned on the bottom surface.

9. A system including:
two exhaust pipe assemblies, each said exhaust pipe assembly being adapted for directing exhaust gases from a first cylinder and a second cylinder of an internal combustion engine respectively along a predetermined path, the internal combustion engine being mounted in a vehicle with a front end and a back end, each of said exhaust pipe assemblies having:
a body with a back end proximal to the vehicle back end and a front end distal to the back end of the body; and
a duct defining the predetermined path and positioned at least partially in the body, the duct having an intake end adapted to receive said exhaust gases from said cylinder and an output end located between the front end and the back end of the body, to direct said exhaust gases along the predetermined path to exit the body;
each said output end being located such that the predetermined path in each said duct has a preselected length.
